(19) United States
(12) Patent Application Publication
(10) Pub. No.: US 2003/0204458 A1
(43) Pub. Date: Oct. 30, 2003

(54) Accrual and validation system, and associated methods

(76) Inventors: Charles T. Carroll, Olathe, KS (US); Sonali V. Joshi, Lenexa, KS (US); Pamela A. Andrew, Chandler, AZ (US)

Correspondence Address: LATHROP & GAGE LC, 2345 GRAND AVENUE, SUITE 2800, KANSAS CITY, MO, 64108, US

(21) Appl. No.: 10/133,462

(22) Filed: Apr. 26, 2002

(51) Int. Cl. G06F 17/60

(52) U.S. Cl. 705/35

(57) ABSTRACT

Systems and processes are disclosed for validating and processing invoices for labor, service contracts, equipment and/or other resources against data representing actual expenditures and expectations set forth by project management systems and software. An accrual and validation database identifies duplicate invoices, erroneous contractor rates and/or erroneous contractor hours by identifying and reporting variances, accrued costs and other information. A project management database associates approved work with sponsoring budget centers so that general ledger transactions may be generated to allocate approved invoice charges. Among other functions, the database may be configured to (a) retrieve project description and actual costing information from project management systems and convert that information into records setting forth per-project, per-day, per-contractor records, (b) validate that a contractor performed work within authorized periods by cross-checking invoices with project schedules and projections, (c) provide reports and analyses per project management requests and/or (d) generate automated transactions to an electronic payment system.

### BACKGROUND OF THE INVENTION

In the prior art, financial managers cannot immediately acquire accurate reports on accrued costs of projects, such as services contracts involving information technology (“IT”). Prior art project management systems may provide for input of actual costs of work performed, but do not, for example, track how such costs are relieved through payment, modification or withdrawal. Accordingly, cross-checking between the management systems and the cost-relieving process is performed manually; companies desiring such a process thus endure an informal, tedious and time-consuming undertaking. In certain circumstances, therefore, the undertaking fails to identify redundant invoices, correlate invoices to the correct company department, locate improper rates per pre-approved contracts, and report violations and other issues relating to contracts involving people or equipment.

The invention seeks to advance the state of the art of project and financial management within corporate IT systems by providing methods and systems for managing and validating accruals, services contracts and equipment within the workflow. Several other features of the invention are apparent within the description that follows.

### SUMMARY OF THE INVENTION

The invention provides, in one aspect, processes and systems for validating and processing invoices for labor, services (e.g., IT service contracts), equipment and/or other resources against data representing actual expenditures and expectations set forth by project management systems and software. The invention thus has particular advantages in identifying duplicate invoices, erroneous contractor rates and/or erroneous contractor hours by identifying and reporting variances, accrued costs and other information.

One system of the invention utilizes a database (e.g., an Oracle database) and software configured to perform one or more of the following functions:

retrieve project description and actual costing information from project management systems and convert that information into records setting forth per-project, per-day, per-contractor records

provide for manual or electronic input of invoices

append descriptive data to received invoices, and check for overlapping and erroneous data

validate, through one or more invoices, that a contractor performed work within authorized periods

cross-check invoice with descriptive and actual cost information for validation of hours, days or other time-period worked; cross-check may involve network retrieval of the information from a project management system or database

generate error messages and/or graphical indicators indicating differences between actual costing information and relevant invoice(s); error messages may be restricted for variances set by user-selected variance allowance

identify duplication within invoice records being processed and records of past, paid invoices relative to time period worked, billing rates and/or other duplications

retrieve actual costing information when no project data is available on the invoice(s) being processed, to display that information as aggregates for a project to assist in processing invoices for multiple projects; retrieval may involve network retrieval of actual costing information from a project management system or database

restrict payment processing of invoice lines outside an allowable invoice period; restriction may be over-ridden by a user-selected variance

allocate invoices among multiple projects, as appropriate, to attribute costs to appropriate cost centers and projects

print hard copies, or publish electronic information, of discrepant conditions such as invoice amount versus work performed as compared to project historical records

facilitate processing of invoices through user-interaction with drop down windows; by way of example, once vendor and time period entered, a resource window may show all contractors who worked for that vendor during that period

save validated invoicing records for use as evidence in future review; an invoice may be partially validated

produce reports of accrued costs by period (e.g., annual, quarterly, monthly, weekly, daily) in either summary or detailed form; reports may be filtered and sorted by budget center, project, vendor, contractor and mixtures thereof

produce reports on various contractor cost metrics, for example identifying most expensive contractors, vendors utilized within certain budget centers, and time delay between work performed, invoice generation, receipt of invoice and invoice validation

track charges of other resource allocations, such as equipment costs, travel, living expenses, and leasing costs

objectify invoicing for purposes of dispute resolution with vendors and contractors, for example to resolve disputes of hours worked and agreed-to rates

indicate invoice location within the process work flow, for example from receipt of invoice to issuing a check to vendor

denote remaining legal obligations to IT vendors at a given time

specify invoice accuracies and duplication rates per contractor or vendor, per project and/or per business segment

As used herein, “actuals” information may include a variety of information, such as the time a person has worked on a task or assignment, or other measurable values, including pounds or kilograms of a particular material. In certain aspects of the invention, actuals are tracked with a project's progress to make future scheduling more accurate. As used herein, “project” may include a related set of tasks performed to achieve a specific objective. As used herein, “tracking” may include processes measuring a status of a project and comparing it to a project plan to identify variances, so that one may take corrective actions.

The invention is next described further in connection with certain embodiments, and it will become apparent that various additions, subtractions, and modifications can be made by those skilled in the art without departing from the scope of the invention.

### BRIEF DESCRIPTION OF THE DRAWINGS

A more complete understanding of the invention may be obtained by reference to the drawings, in which:

FIG. 1 shows a system constructed according to the invention;

FIG. 2 illustrates one program architecture according to the invention;

FIG. 3 and FIG. 4 show additional program architecture of the architecture of FIG. 2;

FIG. 5 sets forth one accrual process illustrating exemplary user interactions with, and architectural relationships between, databases and architectures of the invention;

FIG. 6 shows a schematic illustration of one workflow contractor-vendor accrual process of the invention;

FIG. 7 shows one exemplary accrual calculation process of the invention;

FIG. 8 shows one accrual and validation database structure of the invention;

FIG. 9 shows one software-based workflow process according to one method of the invention;

FIG. 10 shows one software-based duplicates workflow process according to one method of the invention;

FIG. 11 shows one software-based variances workflow process according to one method of the invention;

FIG. 12 shows one exemplary invoice header data entry screen suitable for use with the process of FIG. 9;

FIG. 13 shows one exemplary duplicate invoice line entry data screen that may be generated by the process of FIG. 10; and

FIG. 14 shows one exemplary variance data screen that may be generated by the process of FIG. 11.

### DETAILED DESCRIPTION OF THE DRAWINGS

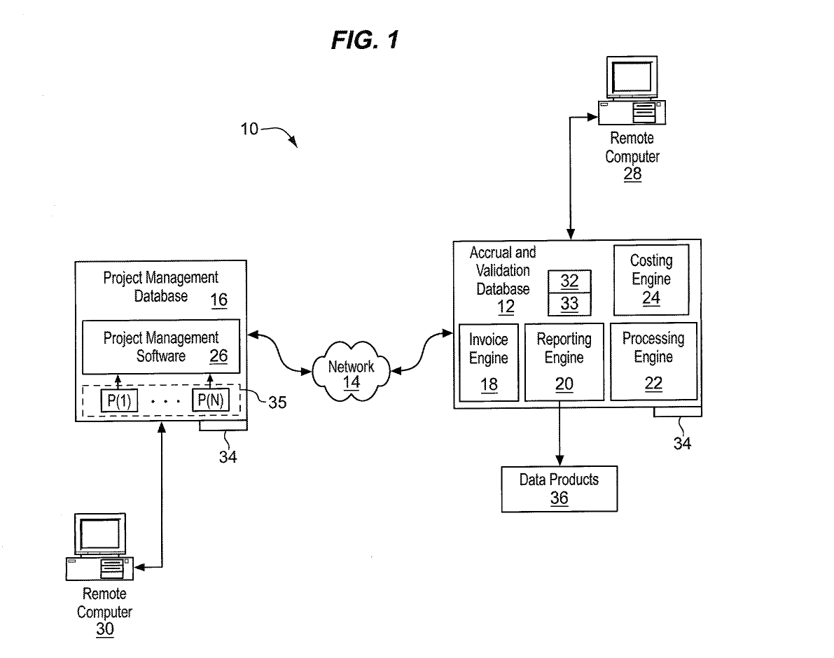

FIG. 1 shows a system 10 constructed according to the invention. System 10 has an accrual and validation database 12 connected by a network 14 to a project management database 16. Accrual and validation database 12 may have an invoice engine 18, reporting engine 20, processing engine 22, and costing engine 24; while project management database 16 may generally include project management software 26. By way of exemplary operation, invoices may be entered into and processed by system 10 via invoice engine 18; reporting engine 20 may report requested or predefined electronic or hard-copy information, including summaries, data variances, reports and/or data products 36, in cooperation with processing engine 22; processing engine 22 may process, synthesize and/or collate data from project management database 16 and from engines 18, 20, 24 to provide various analytical and quantitative functions of the invention; and costing engine 24 may compare and calculate costs in cooperation with processing engine 22. In another exemplary operation, project management software 26 may be used to organize and track project schedules, over time, and to project anticipated costs such as labor, equipment and other resources (collectively “project information”) within those schedules; generally, the project information is collated according to a particular project, such as indicated by projects P(1) . . . P(N), N being the integer number of projects processed within database 16. Project management software 26 may further accept inputs of actual costs of work performed for inclusion within project information P(1) . . . P(N).

Databases 12, 16 may be accessed by remote computers 28, 30, such as to input data and to request detailed reports or other processing by system 10. In one example, a user at computer 28 may manually input or electronically load one or more labor invoices to invoice engine 18. In another example, computer 30 may control, set-up or augment information to a project, e.g., P(1), in conjunction with project management software 26. In yet another example, either computers 28, 30 may request a report or analysis comparing invoices or other information to the project schedules and cost estimates of a particular project PO; they may further request a summary of actual versus expected costs for a particular project P( ), if desired. Engines 18, 20, 22, 24 may cooperate together in response to requests by computers 28, 30 to provide requested functionality as described herein. In one example, database 12 and reporting engine 20 cooperate to publish one or more data products 36, such as summaries, variance notifications and other publications; data products 36 may be in hard-copy form or may instead illustrate an electronic transmission to computers 28, 30.

Those skilled in the art should appreciate that system 10 is shown for illustrative purposes and that changes may be made without departing from the scope of the invention. For example, engines 18, 20, 22, 24 may be formed of one or more software modules under control of a processor 32 within database 12. Database 12 may include memory 33 (e.g., RAM, ROM) to store data for engines 18, 20, 22, 24. Databases 12 and 16 may further be integrated within a common database or server, if desired. In one embodiment, projects P(1) . . . P(N) represent application documents or programs in memory 35 of database 16 and under control of project management software 26. Data may also be input directly to either databases 12, 16 such as through a user interface 34 (e.g., a keyboard).

System 10 may be further configured to provide one or more of the following functions and/or configurations:

(1) processing and costing engines 22, 24 respectively retrieve project description and actual costing information associated with a particular project P( ) of project management database 16, and processing and reporting engines 20, 22 convert that information into records setting forth per-project, per-day, and/or per-contractor records

(2) computers 28, 30 and/or invoice engine 18 provide for manual or electronic input of invoices

(3) computers 28, 30 and/or user interface 34 provide for entering descriptive data to received invoices; processing engine 22 checks for overlapping and erroneous data

(4) processing engine 22 validates that a contractor performed work within authorized periods by cross-checking invoices entered by engine 18 with project schedules and projections within database 16

(5) processing engine 22 cross-checks invoices to description and actual costing information, from the project management database 16, for validation of hours, days or other time-period worked

(6) reporting engine 20 generates error messages and/or graphical indicators for differences between actual costing information and relevant invoices; a user may restrict these error messages to user-selected variance allowances through computers 28, 30 and/or interface 34

(7) reporting engine 20 signals identification of duplicate invoice records relative to time period worked, billing rates and/or other duplications

(8) costing engine 24 retrieves actual costing information from database 12 when no project data is available in database 16, so that reporting engine may display that information as aggregates for a project, to assist in processing invoices relative to multiple projects

(9) processing engine 22 restricts payment processing for invoices outside of an allowable invoice period; restriction may be over-ridden by user-selected variances set through computers 28, 30 and/or interface 34

(10) engines 22, 24 allocate invoices among multiple projects as appropriate to attribute costs to appropriate cost centers and projects

(11) reporting engine 20 prints hard copies or publishes electronic information of discrepant conditions, such as invoice amount versus work performed as compared to project expectations, as data products 36

(12) invoice and processing engines 18, 22 provide for processing of invoices through user-interaction with drop down windows

(13) invoice, processing engine and reporting engines 18, 20, 22 cooperate to save validated invoicing records for use as evidence in future reviews, and permit partial or full validation of an invoice

(14) reporting engine 20 produces reports of accrued costs by period (e.g., annual, quarterly, monthly, weekly, daily) in either summary or detailed form; reports may be filtered and sorted by any combination of budget center, project, vendor, and contractor

(15) reporting engine 20 produces reports on various contractor cost metrics, for example identifying most expensive contractors, vendors used by certain budget centers, and time delay between work performed, invoice generation, receipt of invoice and invoice validation

(16) processing and costing engines 22, 24 cooperate to track charges of resource allocations, such as equipment costs, travel, living expenses, and leasing costs

(17) accrual and validation database 12 resolves disputes with vendors and contractors, cross-checking hours worked and agreed-to rates upon request through computers 28, 30 or user interface 34

(18) reporting engine 20 provides a graphical or textual indication of where an invoice is within the process flow, from receipt of invoice to issuing a check to vendor

(19) reporting engine 20 sets forth remaining legal obligations of IT vendors at any given time

(20) reporting engine 20 specifies invoice accuracies and duplication rates per contractor or vendor, per project and/or per business segment

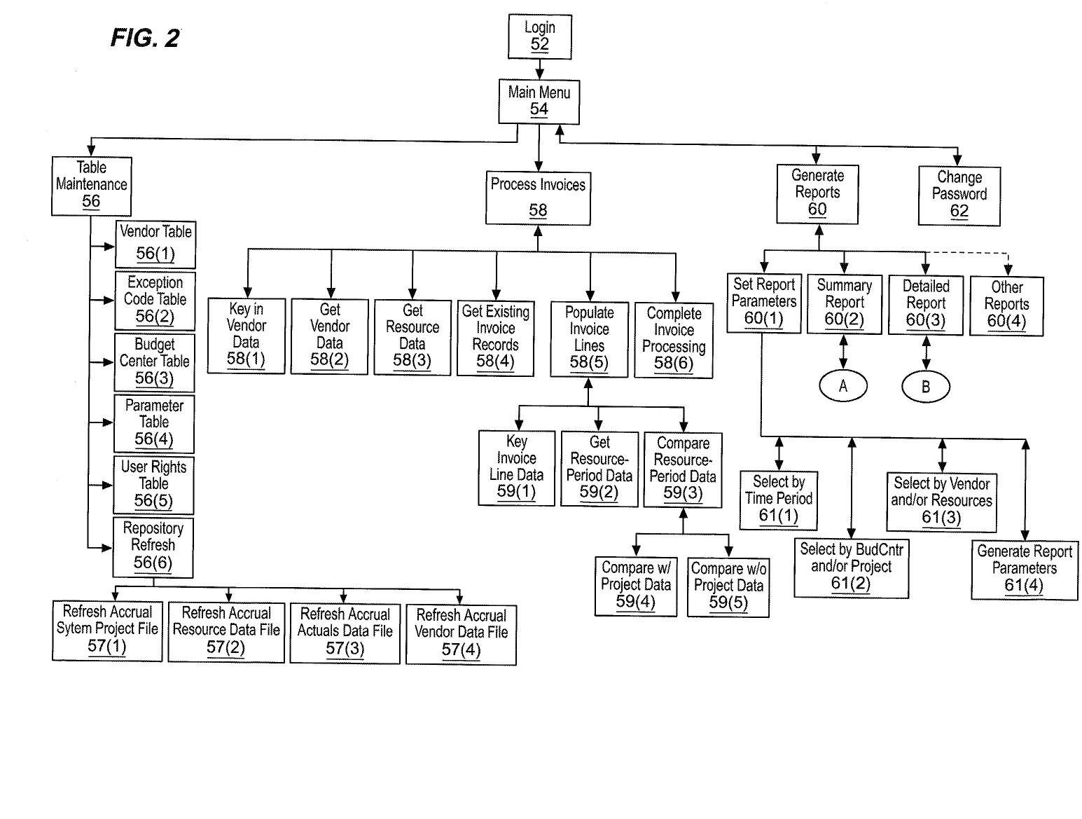

FIG. 2 illustrates one program architecture 50 constructed according to the invention. Architecture 50 may for example be implemented as software within database 12, FIG. 1. Architecture 10 begins at login module 52. A main menu appears at main menu module 54. From module 54, a user may select table maintenance module 56, process invoices module 58, generate reports module 60, and change password module 62. Module 56 may provide access to the following functional modules: vendor table module 56(1) sets forth a listing of vendors; exception code table module 56(2) sets forth error conditions; budget center table module 56(3) sets forth descriptive data about budget centers and associated owners, such as for accrual reports; parameter table module 56(4) sets forth control codes for system processing and reporting, for example data over-ride variances; user rights table module 56(5) sets forth user access and control codes; repository refresh module 56(6) sets forth a scheduled process by which data is extracted from program management database 16 and uploaded to database 12. Module 56(6) may provide access to the following functional modules: refresh accrual system project file module 57(1) runs structured query language to extract project data from projects P( ) of database 16; refresh accrual resource data file module 57(2) runs structured query language to extract resource data from database 16; refresh accruals actual data file 57(3) runs structured query language to extract actuals data from database 16; refresh accrual vendor data file module 57(4) runs structured query language to extract data about vendors.

Process invoices module 58 controls data entry and checking of vendor invoices. By way of example, invoice and processing engines 18, 22 may cooperate to provide functions of module 58. Module 58 may also create database records when an invoice line does not have discrepancies. Module 58 may further provide access to the following modules: key in header data module 58(1) provides for user entry of invoices, such as identifying invoice number, invoice start and end dates, vendor, date invoice received, date invoice approved for payment, and preparer; get vendor data module 58(2) provides for vendor identification entries; get resource data module 58(3) accepts vendor information and the start date of an invoice and retrieves information related to the associated vendor, such as whether the vendor's date of hire is earlier than the invoice end date, and whether the date of termination is either blank or later than the invoice start date; get existing invoice records module 58(4) generates exception messages for already-completed invoices and identifies preexisting invoices; populate invoice lines module 58(5) provides for data entry, recording invoice data, comparing invoice data with historical data, signaling error conditions, and overriding error conditions, per any line of an invoice; complete invoice processing module 58(6) provides for finalizing, or not, approval for invoices, including payment authorization. Module 58(5) may further provide access to sub-modules 59(1)-59(5): key invoice line data module 59(1) provides for entering a budget center or project identifier, start and end dates, labor hours, labor cost and/or expenses, such as travel expenses; get resource-period data module 59(2) queries data tables extracted from database 16 and loads actual hours and billing rates into memory; and compare resource-period data module 59(3) runs a duplicate check comparison and a variance check comparison. Module 59(3) may further provide access to sub-modules 59(4) and 59(5): compare records with project data module 59(4) compares keyed invoices to project data to locate duplication; compare records without project data module 59(5) compares invoice indicators with keyed invoices to locate duplication.

Generate reports module 60 may contain menu, parameter setting functions and report generation routines. By way of example, reporting engine and processing engine 20, 22 may cooperate to provide functions of module 60. Module 60 may provide access to the following modules: set report parameters module 60(1) provides for setting report parameters, such as budget center, project time period, vendor and resource; generate summary report module 60(2) provides for summary report generation; generate detailed report module 60(3) provides for detailed report generation; and other report module 60(4) provides for user-selected reports. Module 60(1) may provide access to the following sub-modules: select by time period module 61(1) provides for user time period selection; select by budget center and/or project module 61(2) provides for user selection of budget center and/or project; select by vendor and/or resources module 61(3) provides for user-selection of vendors and/or resources, for reporting purposes; and generate report parameters module 61(4) builds report selection criteria based on user selections.

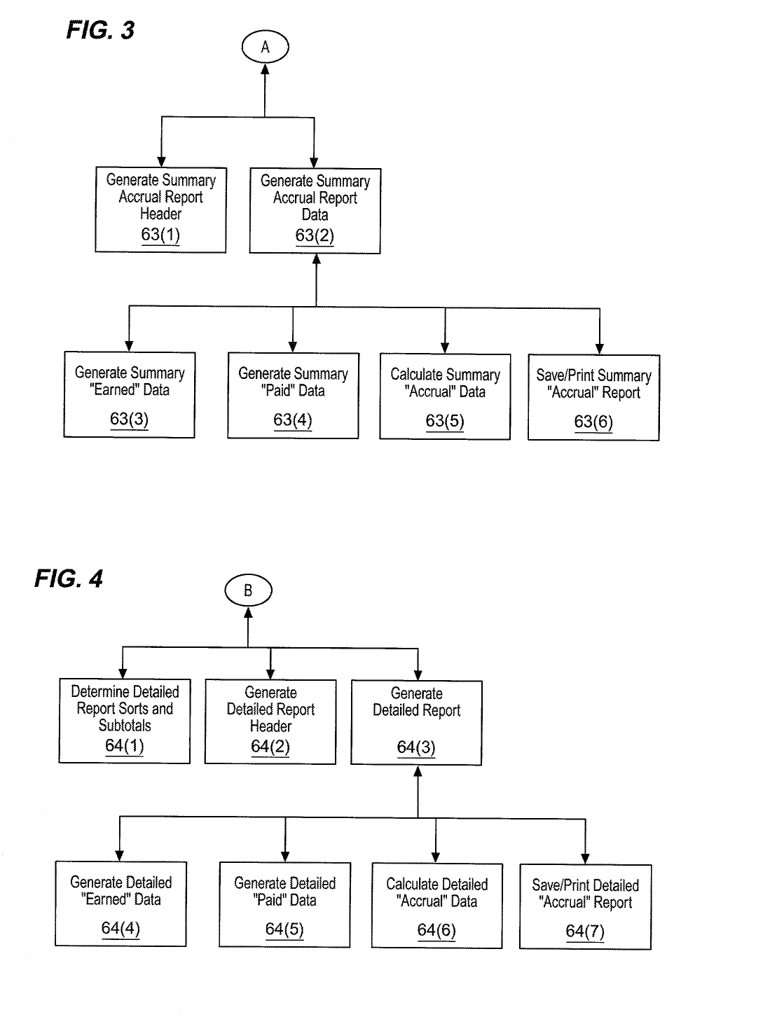

Generate summary report module 60(2) may provide access to the following modules as set forth in FIG. 3: generate summary accrual report header module 63(1) provides for header generation of a summary report; and generate summary accrual report data module 63(2) provides for data generation of a summary report. Generate summary accrual report data module 63(2) may provide access to the following modules: generate summary “earned” data module 63(3) provides for data generation of earned data of a summary report; generate summary “paid” data module 63(4) provides for data generation of paid data in a summary report; calculate summary “accrual data” module 63(5) provides for data generation of accrual data in a summary report; and save/print accrual summary report module 63(6) provides for saving and/or printing of summary accrual reports.

Generate detailed report module 60(3) may provide access to the following modules as set forth in FIG. 4: determine detailed report sorts and subtotals module 64(1) provides for generation of detailed and sorted reports and subtotals; generate detailed report header module 64(2) provides for generating a detailed report header; and generate detailed report module 64(3) provides for generating one or more detailed reports. Generate detailed report module 64(3) may provide access to the following modules: generate detailed “earned” data module 64(4) provides for data generation of earned data of a detailed report; generate detailed “paid” data module 64(5) provides for data generation of paid data in a detailed report; calculate detailed “accrual” data module 64(6) provides for data generation of accrual data in a detailed report; and save/print detailed “accrual” report module 64(7) provides for saving and/or printing of detailed accrual reports.

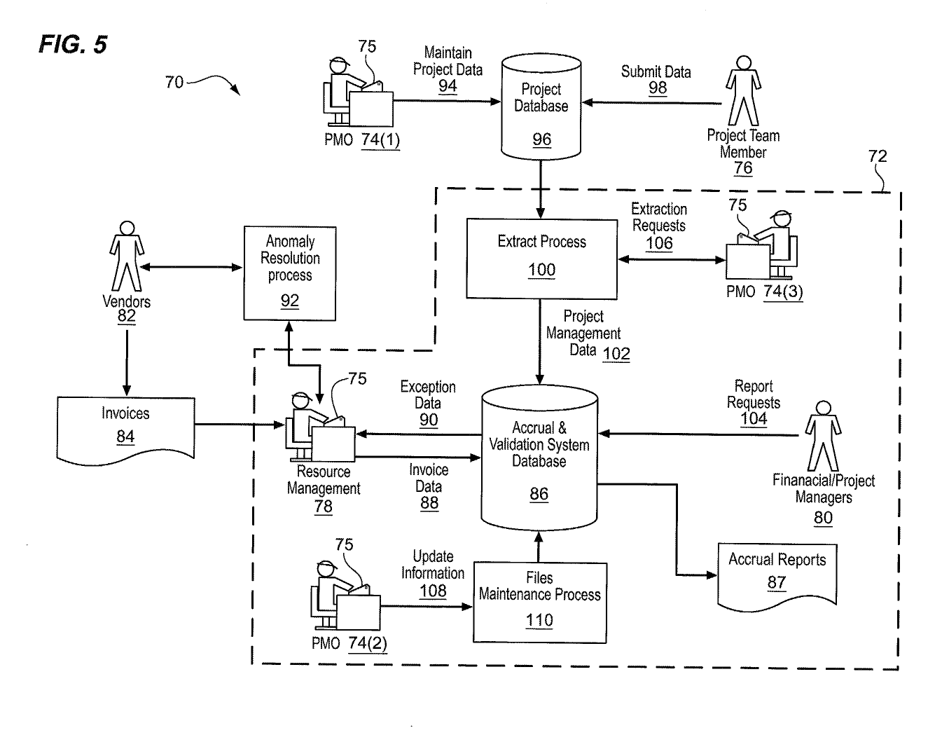

FIG. 5 sets forth one accrual process 70 illustrating exemplary user interactions with one accrual and validation system 72, in accord with the invention; system 72 is shown as a dotted outline for purposes of illustration and may for example operate like program architecture 50, FIG. 2. Process 70 typically operates in the context of a corporation with one or more project management office (“PMO”) users 74, one or more project team members 76, one or more resource management users 78, and one or more financial or project managers 80. Users 74, 78 may for example interact with system 72 with remote computers 75; computers 75 may for example take the form of computer 28 or 30, FIG. 1.

In operation, one or more vendors 82 submits invoices 84 to system 72. Resource management personnel 78 input invoices 84 to an accrual and validation system database 86 as input data 88, as shown; database 86 may for example function like database 12, FIG. 1. Database 86 may generate exception data 90 for a variety of reasons, for example if invoices 84 are duplicates of previously-submitted invoices. Database 86 may further resolve disputes with vendors 82 by dispute resolution process 92 with vendors 82; process 92 may for example include publication of data products 36, FIG. 1, setting forth reports of payments made for prior work performed. In one embodiment, database 86 publishes accrual reports 87 in hard-copy or electronic form to facilitate the features of the invention described herein.

A project management user 74(1) may input project management data 94 to a project database 96; project database 96 may for example function like database 16, FIG. 1. Project team member 76 may further input data 98, such as hours worked for a particular project P( ), FIG. 1, to database 96. Interaction between databases 86, 96 and project management user 74(3) may be illustrated as extract process 100; by way of example, process 100 may be performed by engines 18, 20, 22, 24, FIG. 1. Process 100 may include extracting project management data 102 e.g., hours worked and resources, per project P( )—for input to database 86. Managers 80 may submit report requests 104 to system 72; in response to requests 104, user 74(3) may for example submit extraction requests 106 to process 100 to receive electronic summary or detailed reports or to generate accrual reports 87. In another operation, user 74(2) may submit update information 108 to database 86 through a file maintenance process 110. Update information 108 may for example include information, such as update tables, augmenting automatically updated data between databases 86, 96, via process 100.

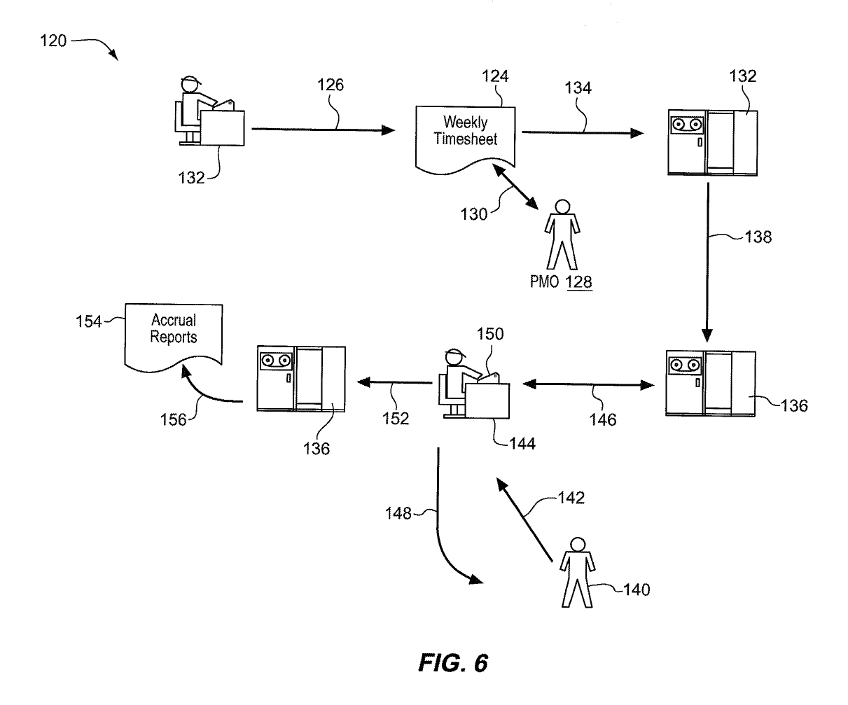

FIG. 6 shows a workflow process 120 illustrating exemplary operations in interacting with system 72, FIG. 5. Contractors 122 perform work for the company utilizing system 72. Contractors 122 submit weekly timesheets 124 to their associated project management office at step 126; timesheets 124 may be approved by a project management official 128, as shown by step 130. Timesheets 124 are submitted to a project management database 132 via step 134; database 132 may for example take the form of database 16, FIG. 1, or database 96, FIG. 5. Certain information from database 132 is extracted and downloaded to an accrual and validation database 136 via step 138; by way of example, database 136 may take the form of database 12, FIG. 1, or database 86, FIG. 5.

A vendor 140 later submits an invoice to process 120 for work performed by contractors 122, via step 142; a resource management person 144 enters the invoice into database 136 via step 146. Data input to database 136 at step 146 is automatically validated, or not, upon entry; person 144 may receive validation information from database 136 at a remote computer 150. If for example the invoice is validated, then a payment is made to vendor 140 at step 148. If on the other hand the invoice is not validated, such as when the invoice is a duplicate, step 148 does not pay vendor 140. A portion of the invoice may also be approved at step 148, whereby vendor 140 receives at least partial payment for the submitted invoice.

At step 152, database 136 is updated with the results of previous steps 126, 134, 142, 146, 148 so that an updated accruals report 154 may be generated, at step 156. Accruals report 154 may for example take the form of report 87, FIG. 5, data products 36, FIG. 1, and/or reports generated in connection with modules 60, 61, 63, 64 of FIG. 2 and FIG. 3.

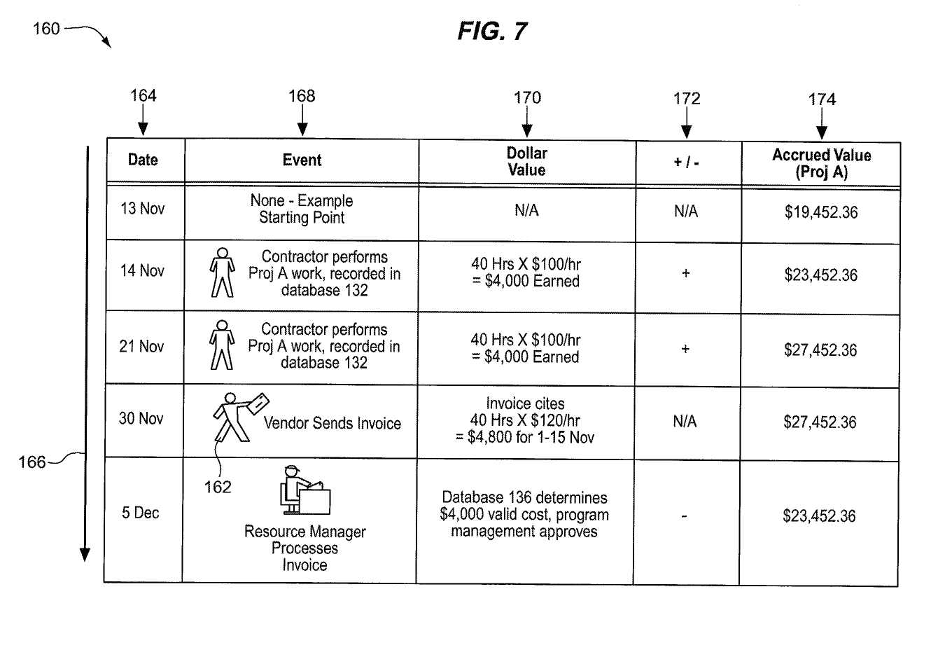

FIG. 7 illustrates one illustrative calculation process 160 showing accruals to a particular project P( ) (called “Project A” within FIG. 7) and subsequent payment to a vendor 162. Column 164 sets forth illustrative dates along a timeline 166. Column 168 sets forth events corresponding to the dates of column 164. Column 170 sets forth dollar values affecting project A and resulting from events of column 168. Column 172 sets forth plus or minus indicators illustrating how dollar values of column 170 impact accruals for project A. Column 174 sets forth accrued dollar values for project A due to interaction with an accrual and validation database (e.g., database 12, FIG. 1, database 86, FIG. 5, database 136, FIG. 6). It is particularly noteworthy that on December 5, calculation process 160 only validated $4,000 of the vendor's $4,800 invoice (submitted November 30 at $120/hour) since the underlying work performed, on November 14, was pre-approved by project management as only $4,000 (at $100/hour). The November 30 invoice thus had no impact on the accrued value of Project A; the accrual and validation database correctly calculated the accrued sum as $23,452.36 on December 5 by validating only $4,000 as approved payment to vendor 162.

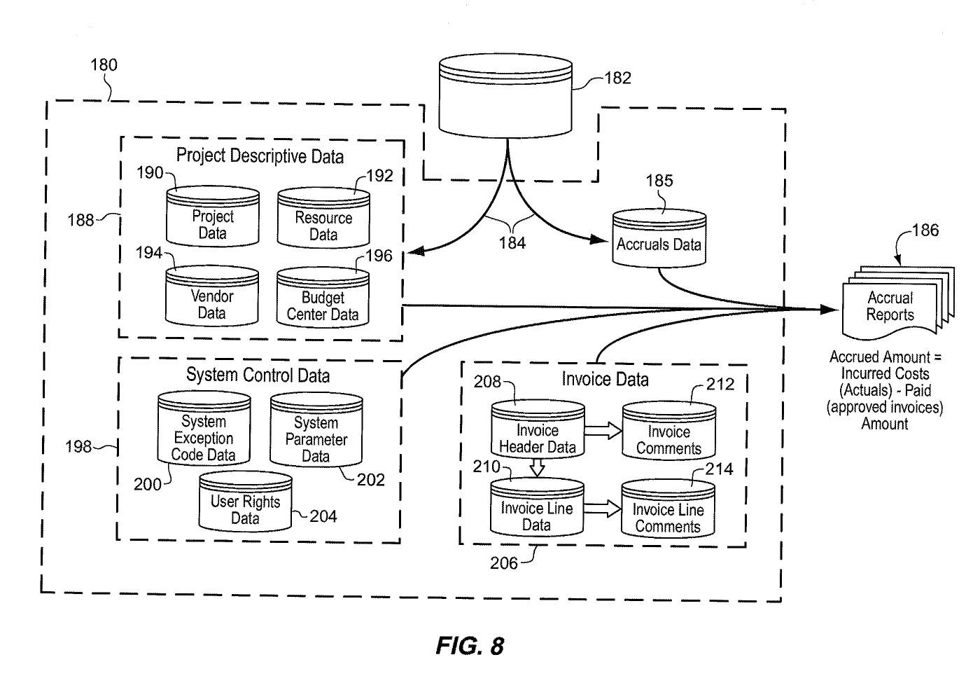

FIG. 8 illustrates one database structure 180 suitable for use with an accrual and validation database of the invention. Structure 180 interacts with a project management database 182, including data extraction 184 of data from database 182, to perform functions described herein such as generating accruals reports 186. Data extraction 184 may include extracting actuals data from database 182 for storage in a data block 185 of structure 180, as shown. Actuals data in block 185 may for example include project labor hours and cost data. Project descriptive data, obtained by extraction 184, may be collated in a data segment 188: project data stored in data block 190, resource data stored in block 192, vendor data stored in block 194, and budget center data stored in block 196. Finance or project management personnel may for example key in vendor identifiers to supplement vendor data in block 194. System control data may be collated in data segment 198: system exception code stored in block 200, system parameter data stored in block 202, and user rights data stored in block 204. Data within blocks 200, 202, 204 may for example be keyed in by project management personnel; user rights data in block 204 may for example include user passwords to authorize use of structure 180. Invoice data may be collated in data segment 206: invoice header data stored in block 208, invoice line data stored in block 210, invoice comments stored in block 212, and invoice line comments stored in block 214. Data within blocks 208, 210, 212, 214 may for example be keyed in by resource management personnel.

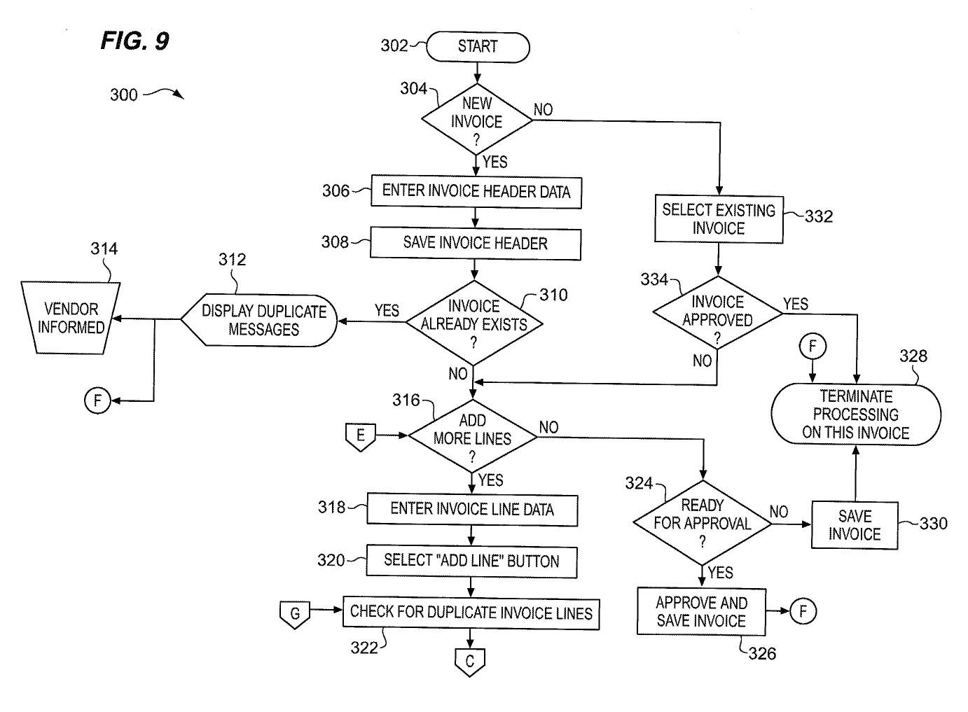

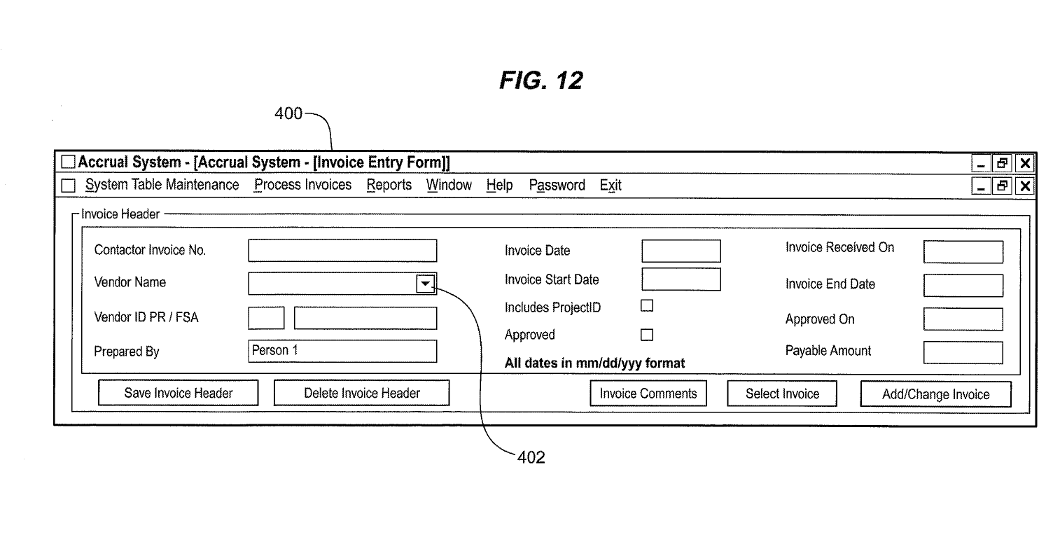

FIG. 9 shows a software-based workflow process 300 according to one method of the invention. Process 300 begins at start step 302. At decision step 304, a user is queried whether is to enter a new invoice or locate an existing invoice. After the “yes” branch from decision step 304, the user may enter invoice header data in step 306. FIG. 12 shows one exemplary invoice line entry data screen 400 that may be presented to a user at step 306; data screen 400 may for example be presented to the user at remote computer 28, FIG. 1. As shown in FIG. 12, data entry screen 400 may for example include the following non-limiting illustrative inputs: invoice number, as printed on the invoice; data of invoice, as printed in the invoice; date of receipt of invoice by the company using process 300; vendor name, which may be selected via drop-down box 402, accessing previously stored vendor names within system databases; invoice start date, as printed in the invoice; invoice end date, as printed in the invoice; and project identifier (“projectID”), indicating whether the invoice identifies a particular project.

The header data entered in step 306, and/or in ata screen 400, may be saved in step 308. A cross-check is performed at step 310 to determine whether the invoice entered in step 308 was previously entered. In the event the invoice is a duplicate, a message is generated at step 312 informing the user of the duplication. If desired, the user may notify the vendor that submitted the duplicate invoice, in step 314. Step 314 may be performed automatically by the accrual and validation database, such as by email notification of the vendor through an Internet network.

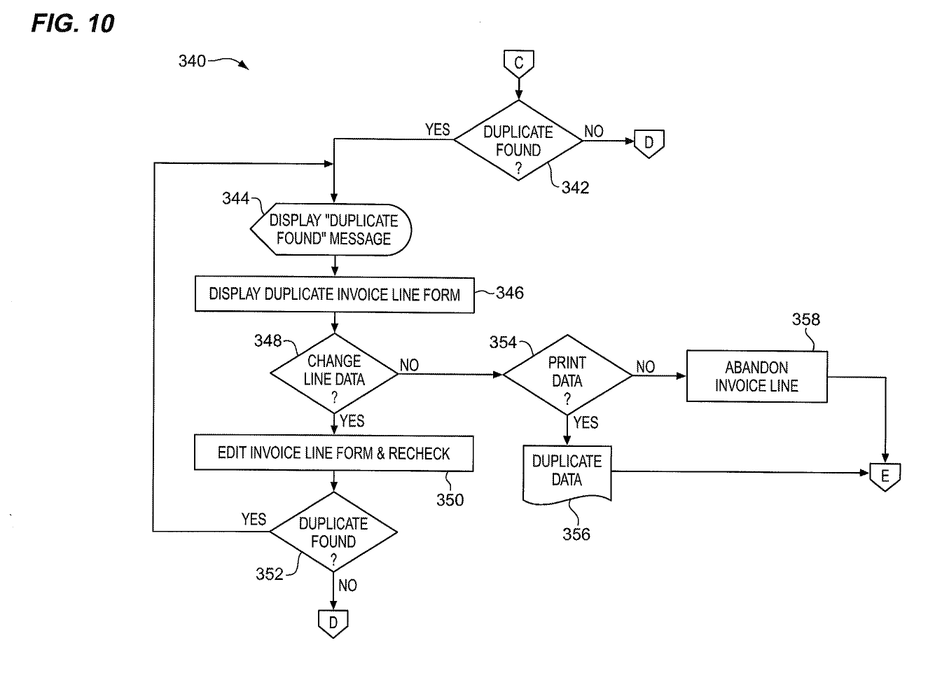

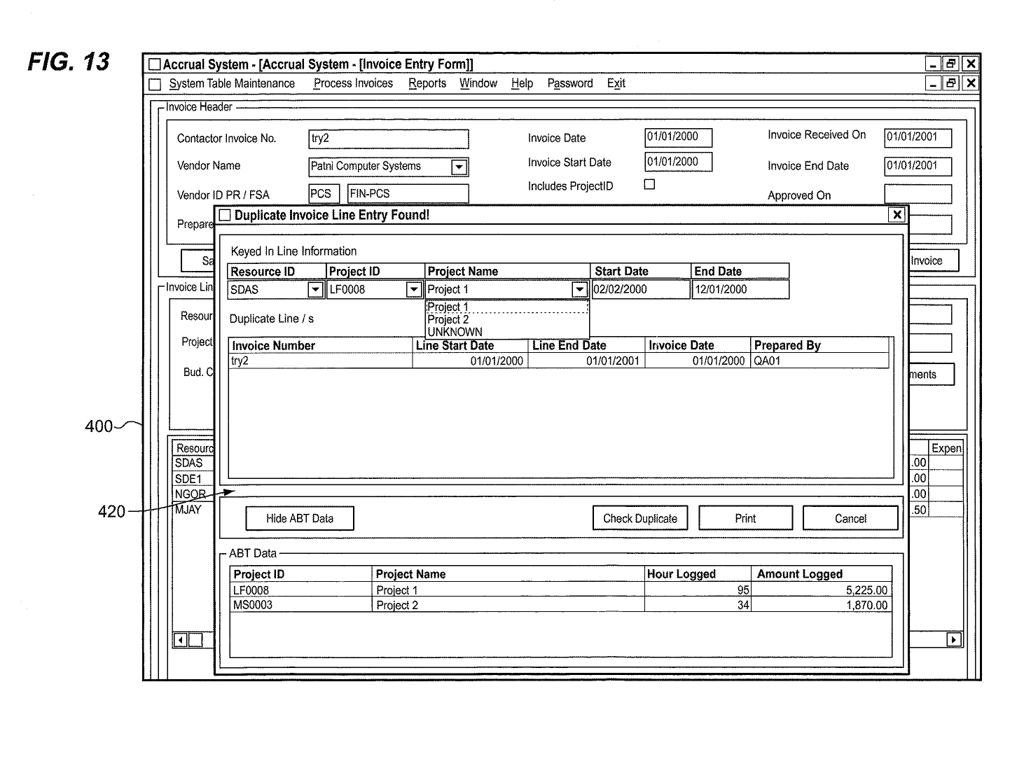

If the current invoice is not a duplicate, step 316 may proceed following cross-check step 310. Step 316 in particular provides for adding lines to the current invoice. If the user wishes to add more lines, the additional invoice line data is entered at step 318. Additional invoice lines may be entered at step 320. Similar to step 310, a cross-check is performed at step 322 as to whether duplicates exist of the entered invoice lines of step 318. FIG. 13 shows one exemplary data screen 420 that may be presented to the user in connection with step 322; duplicate invoice line entry data screen 420 may for example inform the user of the duplication. Additional invoice line steps 316, 318, 320 provide for appending additional information to the standard header entries of step 306. This additional information may for example include hours claimed within the invoice, labor or equipment costs claimed, expenses claimed, and other data suitable for cross-checking within step 322 to locate improper duplications. In the event of duplication, duplicates workflow process 340 of FIG. 10 commences, as indicated.

In the event that a user does not select entry of additional invoice lines per steps 316-320, step 316 may branch to decision step 324, for approval of the invoice. If the invoice is approved, step 326 commences, to save the approved invoice. Step 326 may further process to step 328, as shown, to terminate processing of the current invoice. If the invoice is not approved, step 324 may branch to save the unapproved invoice in step 330.

One branch from decision step 304 may lead to step 332 when the user wishes to select an existing invoice. Step 332 may lead to an invoice approval decision at step 334. If approved, the user may branch to step 328, as above; if the invoice is not approved, continued processing resumes at step 316, as shown.

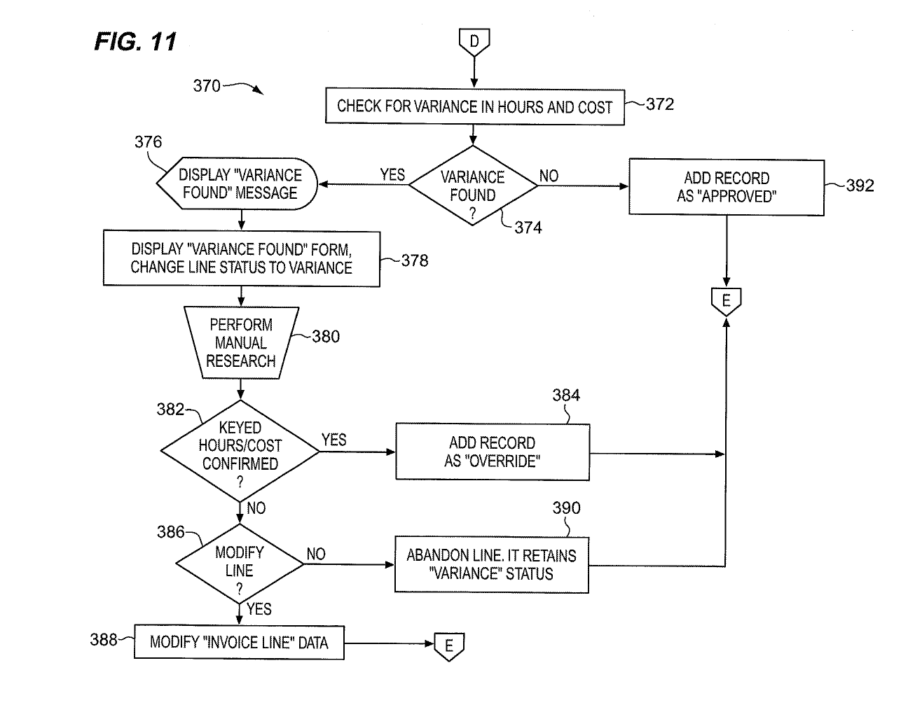

Workflow process 340 of FIG. 10 connects with process 300 following step 322. If a duplicate invoice line is detected, step 342, a message or indicator is generated informing the user of duplication, in step 344. The display of a duplicate invoice line form may then be displayed in step 346. Screen 420, FIG. 13, shows one such exemplary duplicate invoice line entry screen that may appear on the user's computer screen in connection with step 346. A user may then change line date of the invoice, or not, in decision step 348. The user may edit the invoice and recheck the invoice lines in step 350; by way of example, if an obvious error is seen in the invoice and the user understands how to make the correction, it may be made in step 350. In step 352, a cross-check of the data entered within step 350 again determines whether duplication exists: if yes, step 344 again commences; if no, workflow process 370, FIG. 11, commences as shown.

If invoice line data is not changed following step 348, a print data step 354 may commence as shown, so as to print, for example, duplicate data 356; data 356 may for example be used in contacting the vendor linked with the duplicate invoice data. Optionally, the duplicate invoice line may be discarded, in step 358.

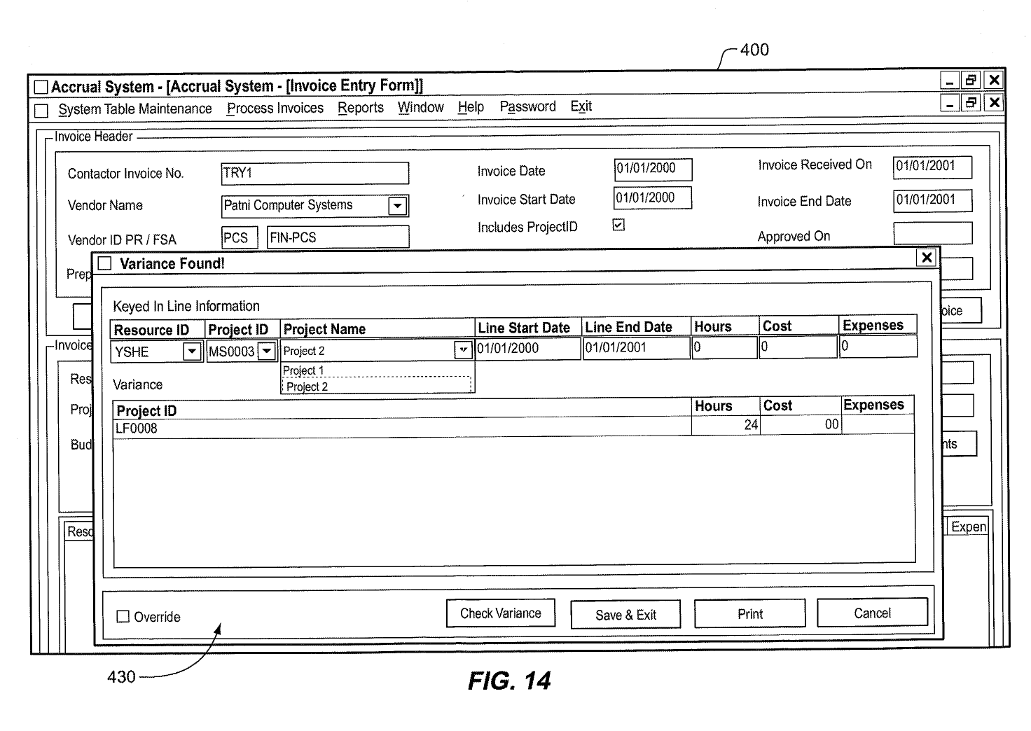

FIG. 11 shows a flowchart illustrating variances workflow process 370 according to one method of the invention. Step 372 checks for variances in hours and/or costs of an invlice. At decision step 374, if a variance is found, step 376 commences, to inform the user of the variance, e.g., by generating a message. A display of a variance found form may then commence in step 378. FIG. 14 shows one exemplary variance found form 430.

If desired, process 370 may pause for a manual search step 380. By way of example, a project management official may be contacted in step 380 to confirm or deny vendor costs associated with the invoice containing the variance. At step 382, a confirmation may be performed relative to keyed-in costs and hours. If confirmation is made, step 384 commences to add the record as an override. If confirmation is not made, decision step 386 commences to modify, or not, the invoice line containing the variance. If the line is to be modified, step 388 commences. If the line is not to be modified, step 390 commences to abandon the line but retain a variance status. From steps 384 or 390, a variance record may be approved as shown by step 392.

Those skilled in the art should appreciate that certain changes may be made to the invention without departing from the scope thereof. By way of example, in one embodiment a user may append electronic notes to the invoice information in response to user inputs associated with a particular invoice. An icon may be displayed in association with the electronic notes. The icon may be shown to all persons and/or inhibited from certain persons, such as the person who made the notes. Electronic notes may also be appended to one or more lines associated with the particular invoice; the icon can then be associated with the one or more lines. In one embodiment, the display of the icon is shown when a user selects the invoice information of the one or more lines; the icon may also disappear, such as when the user moves on by scrolling. The electronic notes may also automatically identify the user who entered the notes, to maintain a record. Additional electronic notes may also be appended in date order, to facilitate future auditing of the notes.

Since certain changes may be made in the above methods and systems without departing from the scope of the invention, it is intended that all matter contained in the above description or shown in the accompanying drawing be interpreted as illustrative and not in a limiting sense. It is also to be understood that the following claims are to cover all generic and specific features of the invention described herein, and all statements of the scope of the invention which, as a matter of language, might be said to fall there between.

What is claimed is:

1. An accrual and validation system, comprising:
project management software for managing project information of one or more projects; and
an accrual and validation database configured for cooperation with the project management software to (a) input invoice information from at least one invoice relating to one or more of the projects and (b) validate, or not, at least part of the invoice through electronic processing of the project information and the invoice information.

2. An accrual and validation system of claim 1, further comprising a project management database configured to process the project management software.

3. An accrual and validation system of claim 1, the accrual and validation database configured to process the project management software.

4. An accrual and validation system of claim 1, the invoice setting forth costs selected from the group consisting essentially of labor costs, services costs, IT contract costs, equipment costs, resource costs and mixtures thereof.

5. An accrual and validation system of claim 1, the accrual and validation database configured for comparing invoice information against actuals information entered through the project management software.

6. An accrual and validation system of claim 1, the accrual and validation database configured for identifying a duplicate invoice.

7. An accrual and validation system of claim 6, the accrual and validation database configured to generate one or both of a message and data screen in response to identification of the duplicate invoice.

8. An accrual and validation system of claim 1, the accrual and validation database configured to identify a duplicate line of the invoice.

9. An accrual and validation system of claim 8, the accrual and validation database configured to generate one or both of a message and data screen in response to identification of the duplicate line.

10. An accrual and validation system of claim 9, the data screen enabling user modification of the invoice information such that the accrual and validation database approves remaining, non-duplicate charges of the invoice.

11. An accrual and validation system of claim 1, the accrual and validation database configured to (a) retrieve, over network, project description and actuals information developed through the project management software and (b) convert the actuals information into one or more of per-project, per-day, per-contractor, per lease and per purchase records.

12. An accrual and validation system of claim 1, the accrual and validation database configured for one or both of manual and electronic input of the invoice.

13. An accrual and validation system of claim 1, the accrual and validation database configured to append descriptive data to the invoice.

14. An accrual and validation system of claim 13, the accrual and validation database configured to check for erroneous data within the invoice.

15. An accrual and validation system of claim 1, the accrual and validation database configured to validate, through the invoice, whether a contractor performed work within authorized periods set forth by the project management software.

16. An accrual and validation system of claim 1, the accrual and validation database configured to cross-check the invoice with descriptive and actuals information set forth by the project management software to validate a time-period worked.

17. An accrual and validation system of claim 1, the accrual and validation database having a network connection with a project management database associated with the project management software.

18. An accrual and validation system of claim 1, the accrual and validation database configured to generate one or both of error messages and graphical indicators regarding differences between actuals information and the invoice.

19. An accrual and validation system of claim 18, the accrual and validation database responsive to user inputs to set a variance for the differences.

20. An accrual and validation system of claim 1, the accrual and validation database configured to input a plurality of invoice records relating to one or more of the projects, the accrual and validation database being further configured to identify duplication within the invoice records and relative to one or both of the invoice and previously stored records of paid invoices.

21. An accrual and validation system of claim 20, the accrual and validation database configured to identify duplication within the invoice records relative to time period worked and billing rate of the previously stored records.

22. An accrual and validation system of claim 20, the accrual and validation database configured to restrict payment processing of invoice lines outside an allowable invoice period.

23. An accrual and validation system of claim 22, the accrual and validation database being responsive to a user-selected variance to ease restriction of payment processing relative to the allowable invoice period.

24. An accrual and validation system of claim 1, the accrual and validation database configured to allocate the invoice among multiple projects to attribute costs to multiple cost centers.

25. An accrual and validation system of claim 1, the accrual and validation database configured to publish information of discrepant conditions of the invoice, the conditions being dependent upon invoice amount versus work performed as compared to project records from the project management software.

26. An accrual and validation system of claim 1, the accrual and validation database configured to facilitate processing of the invoice through user-interaction with drop down windows.

27. An accrual and validation system of claim 26, the drop down windows listing contractors previously stored within the accrual and validation database.

28. An accrual and validation system of claim 1, the accrual and validation database configured to produce reports of accrued costs by period.

29. An accrual and validation system of claim 28, the accrual and validation database configured to filter data for the reports by budget center, project, vendor, contractor and mixtures thereof.

30. An accrual and validation system of claim 28, the accrual and validation database configured to produce the reports for a period selected from the group consisting of one year, one month, one week, and one day.

31. An accrual and validation system of claim 28, the accrual and validation database configured to identify, in the reports, one or more of (a) a most expensive contractor, (b) which vendors were utilized within which budget centers, and (c) a time delay between work performed and one or more of invoice generation, receipt of invoice and invoice validation

32. An accrual and validation system of claim 1, the accrual and validation database configured to track charges of resource allocations.

33. An accrual and validation system of claim 32, the resource allocations being selected from the group consisting essentially of equipment costs, travel costs, living expenses, and leasing costs.

34. An accrual and validation system of claim 1, the accrual and validation database configured to indicate invoice location within a process workflow.

35. An accrual and validation system of claim 1, the accrual and validation database configured to specify one or both of invoice accuracies and duplication rates per-contractor, per-project and per-business segment.

36. An accrual and validation system of claim 1, the accrual and validation database comprising an invoice engine for inputting the invoice to the accrual and validation database.

37. An accrual and validation system of claim 1, the accrual and validation database comprising a reporting engine for reporting data products.

38. An accrual and validation system of claim 37, the reporting engine being responsive to user requests to generate the data products.

39. An accrual and validation system of claim 1, the data products being selected from the group consisting essentially of summary reports and detailed reports.

40. An accrual and validation system of claim 1, the accrual and validation database comprising a processing engine for synthesizing invoice information of the accrual and validation database with the project information.

41. An accrual and validation system of claim 1, the accrual and validation database comprising a costing engine for calculating accrual information from (a) invoice information in the accrual and validation database and (b) the project information.

42. An accrual and validation system of claim 1, the project management software configured to organize and track one or both of anticipated and actual costs of the projects.

43. An accrual and validation system of claim 1, further comprising a project management database operating the project management software, and a network connecting the project management database to the accrual and validation database.

44. An accrual and validation system of claim 1, further comprising a user interface for inputting the invoice.

45. An accrual and validation system of claim 1, the accrual and validation database being configured with at least one of a project descriptive data segment, a system control data segment, an invoice data segment, and actuals data.

46. An accrual and validation system of claim 45, the accrual and validation database configured to extract at least one of the actuals data and the project descriptive data from a database associated with the project management software.

47. An accrual and validation system of claim 45, the accrual and validation database configured for user input of at least one of the system control data and the invoice data.

48. An accrual and validation system of claim 1, the accrual and validation database configured to specify one or both of invoice accuracies and duplication rates per-contractor, per-project or per-business segment.

49. An accrual and validation system of claim 1, the accrual and validation database configured to append electronic notes to the invoice information in response to user inputs associated with a particular invoice.

50. An accrual and validation system of claim 49, the accrual and validation database configured to display an icon associated with the electronic notes.

51. An accrual and validation system of claim 50, the accrual and validation database configured to inhibit display of the icon to the user entering the inputs.

52. An accrual and validation system of claim 49, the accrual and validation database configured to append electronic notes to one or more lines associated with the particular invoice.

53. An accrual and validation system of claim 52, the accrual and validation database configured to display an icon associated with the electronic notes for the one or more lines.

54. An accrual and validation system of claim 53, the accrual and validation database configured to display the icon to persons communicating with the system.

55. An accrual and validation system of claim 54, the accrual and validation database configured to inhibit display of the icon to the user entering the inputs.

56. An accrual and validation system of claim 52, the accrual and validation database configured to display the icon when a user selects the invoice information of the one or more lines.

57. An accrual and validation system of claim 52, the accrual and validation database configured to remove the display of the icon from the one or more lines when a user scrolls beyond the one or more lines.

58. An accrual and validation system of claim 52, the accrual and validation database appending user information to the electronic notes to identify which user formulated the electronic notes.

59. An accrual and validation system of claim 52, the accrual and validation database configured to append, in date order, a plurality of electronic notes.

60. A process for managing invoices, comprising the steps of:
entering invoice information associated with the invoices to a database;
electronically synthesizing the invoice information with project information generated by project management software to identify duplication in the invoice information; and
automatically authorizing payment, or not, of at least part of the invoices that are free of the duplication.

61. A process of claim 60, the step of electronically synthesizing comprising evaluating individual lines of the invoices with data (a) from the database and (b) associated with the project management software.

62. A process of claim 60, further comprising the step of generating one or both of a message and a data screen upon identifying the duplication.

63. A process of claim 60, further comprising automatically processing payment for part of the invoices authorized for payment.

64. A process of claim 60, further comprising appending one or more additional lines of invoice information to data records of the invoices, wherein the step of electronically synthesizing comprises synthesizing the invoice information with the project information to identify duplication, per line, in the invoice information.

65. A process of claim 60, further comprising the step of converting the invoice information into one or more per-project, per-day and per-contractor data records.

66. A process for managing invoices, comprising the steps of:
entering invoice information associated with the invoices to a database;
electronically synthesizing the invoice information with project information generated by project management software to identify variances in the invoice information; and
automatically authorizing payment, or not, of at least part of the invoices that are free of the variances.

67. A process of claim 66, the step of electronically synthesizing comprising evaluating individual lines of the invoices with data (a) from the database and (b) associated with the project management software.

68. A process of claim 67, further comprising the step of generating one or both of a message and a data screen upon identifying the variances.

69. A process of claim 66, further comprising automatically processing payment for part of the invoices authorized for payment.

70. A process of claim 66, further comprising appending one or more additional lines of invoice information to data records of the invoices, wherein the step of electronically synthesizing comprises synthesizing the invoice information with the project information to identify variances, per line, in the invoice information.

71. A process of claim 66, further comprising the step of converting the invoice information into one or more of per-project, per-day and per-contractor data records.

72. A process of claim 66, further comprising entering user-defined variances to the database to modify identification of the variances.

73. A process of claim 66, further comprising electronically indicating a location of one or more invoices within a process workflow between invoice receipt and invoice payment.

74. A process of claim 73, further comprising generating a user request, the step of indicating being responsive to the step of generating.

75. An accrual and validation system, comprising:
a project management database for processing project management software to manage project information of one or more projects; and
an accrual and validation database configured for cooperation with the project management software, the accrual and validation database having (a) means for inputting invoice information relating to invoices for the projects; and (b) means electronically synthesizing the project information with the invoice information to validate for payment at least a portion of one or more of the invoices.

76. An accrual and validation system of claim 75, further comprising (i) means for comparing invoice information against actuals information entered through the project management software, (ii) means for detecting one or both of duplication and variances within the invoice information and project information, and (iii) means for indicating one or both of the duplication and variances to a user connected with either of the databases

77. An accrual and validation system, comprising an accrual and validation software module configured for cooperation with project management software that processes one or more projects, the accrual and validation software module having (a) input means to input invoice information from at least one invoice relating to one or more of the projects and (b) validation means to validate, or not, at least part of the invoice through electronic processing of the project information and the invoice information.
